(19) United States
(12) Patent Application Publication
(10) Pub. No.: US 2015/0167931 A1
(43) Pub. Date: Jun. 18, 2015

(54) PROCESS FOR EQUIPPING LIGHTING SOURCES, CORRESPONDING DEVICES AND ASSORTMENT

(71) Applicant: OSRAM GmbH, Muenchen (DE)

(72) Inventors: Frederic Borgarelli, Treviso (IT); Renato Frison, Chions PN (IT); Antonio Favretto, Codogne (IT); Alessio Sagliocco, San Dona di Piave (IT)

(21) Appl. No.: 14/408,295

(22) PCT Filed: Jul. 1, 2013
(86) PCT No.: PCT/EP2013/063857

§ 371 Date: Dec. 16, 2014

(30) Foreign Application Priority Data
Jul. 2, 2012 (IT) TO2012A000585

(51) Int. Cl. F21V 13/02

(52) U.S. Cl. CPC F21V 13/02; F21Y 2101/02

(57) ABSTRACT

A solid state lighting source may include a reflector having a proximal opening for receiving the light radiation of the source, and an anti-glare device which has a support structure and can be located at a position facing the source to be impinged upon by the light radiation of the source.

Onto the source there is fitted a ring adapter with a smooth reflective inner surface to reflect the light radiation. The ring adapter has an outer rim coupleable to the proximal opening of the reflector and an inner rim coupleable with the support structure of the anti-glare device. It is thereby possible to fit on the source a reflector by coupling the proximal opening of the reflector with the outer rim of the adapter, and fit on the source an anti-glare device by coupling the support structure of the anti-glare device with the inner rim of the adapter.

### RELATED APPLICATIONS

The present application is a national stage entry according to 35 U.S.C. §371 of PCT application No.: PCT/EP2013/063857 filed on Jul. 1, 2013, which claims priority from Italian application No.: TO2012A000585 filed on Jul. 2, 2012, and is incorporated herein by reference in its entirety.

### TECHNICAL FIELD

Various embodiments can relate to solid state lighting sources, for example with LED light radiation sources.

### BACKGROUND

At present, there are various ongoing activities for the standardization of solid state lighting sources, for example as far as the LED modules are concerned. These activities concern both mechanical aspects (for example dimensions of the housings, center distances of the fixing screws, etc.) and aspects of an optical nature (for example light emission angles).

Some solid state lighting sources, though being similar to one another, can differ from one another in terms of shapes and dimensions of the housing, for example owing to the fact that they are a discrete LED source or a Chip on Board (CoB) with differing distances of optical contact and light emitting surfaces (LES).

These aspects can assume particular significance if it is desired to equip a lighting source of this type with a reflector (for example a reflector with a diverging shape such as a paraboloid shape) intended to receive the light radiation of the source to reflect it and project it toward the area to be illuminated and/or with an anti-glare device intended to be impinged upon by the light radiation of the source to avoid a situation where whoever directly observes the source may be blinded.

Moreover, it may be preferable that the same lighting source can be equipped with reflectors having differing dimensions and/or shapes depending on the specific applicable requirements.

### SUMMARY

In various embodiments, a process is provided. Various embodiments may also relate to components which can be used for this purpose and to an assortment of these components. Various embodiments provide for associating an adapter ring with a specific type of light radiation source, for example a solid state light radiation source (such as what is known as a spot LED light engine). In various embodiments, an adapter ring can be of the same type for differing light radiation sources.

In various embodiments, the inner surface of an adapter ring can be smooth and reflective, and therefore the light radiation which is incident thereon is not lost. In various embodiments, an adapter ring can be provided with an outer annular rim and/or with an inner annular rim, which bear coupling formations to allow for coupling with a reflector and/or with an anti-glare device (possibly with a radiation blending function). In various embodiments, an adapter ring can be present integrally within the housing of the light radiation source, for example of the LED type, being located, for example, above the area of optical contact. In various embodiments, an adapter ring can have an annular groove suitable for receiving the base (or proximal rim) of the reflectors.

In various embodiments, an adapter ring can allow for coupling with reflectors of differing shapes, possibly within the context of lighting systems including a plurality of light radiation sources. Various embodiments therefore make it possible to combine in a single device (lighting device or luminaire) a plurality of selected components in an assortment, thereby satisfying a need for a modular design.

### BRIEF DESCRIPTION OF THE FIGURES

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 is a general exemplary exploded perspective view of embodiments,

FIGS. 2 to 4 show various components according to various embodiments, and

FIGS. 5 to 7 further show various possible uses of embodiments.

### DETAILED DESCRIPTION

The following detailed description refers to the accompanying drawing that show, by way of illustration, specific details and embodiments in which the disclosure may be practiced.

The reference to “an embodiment” in the context of this description indicates that a particular configuration, structure or feature described in relation to the embodiment is included in at least one embodiment. Therefore, phrases such as “in one embodiment”, which may occur at various points in this description, do not necessarily refer to the same embodiment. Moreover, particular forms, structures or features may be combined in any suitable manner in one or more embodiments.

The reference signs used here are provided solely for the sake of convenience and therefore do not define the scope of protection or ambit of the embodiments.

Various embodiments can be used to equip a lighting source L, for example a solid state lighting source, with various accessories (as illustrated in more detail hereinbelow). The lighting source, which per se may not be included in the embodiments, can be of any known type.

An LED source can be an example of such a lighting source.

The examples shown here refer to a type which is sufficiently common at the present moment, in which an LED lighting source L is present substantially in the form of a disk with a central portion S, hollowed out for example, where the light radiation emitting surface is located.

Various embodiments may make it possible for one or both of the following to be coupled to the lighting source L:
a reflector 10 with a proximal opening 12, and/or
an anti-glare device 14.

In various embodiments, the reflector 10 can be a paraboloid reflector, or generally have a shape which diverges starting from the opening 12, and therefore, when associated with the lighting source L, the reflector 10 is able to receive through the opening 12 the light radiation emitted by the source so as to reflect it and thus project it forward toward the lighting area.

In various embodiments, the device 14 can be what is known as a dome which can be located at a position facing the lighting source L so as to be impinged upon by the light radiation emitted by said source. The device 14 can thus perform a screening function so as to avoid blinding whoever directly observes the source L.

The possible identification of the device 14 as a dome corresponds to a current classification which may also disregard the specific shape of said device: for example, in the exemplary embodiments illustrated in the accompanying figures (cf. for example FIG. 3), the device in question is substantially shaped like a trumpet-shaped diffusor.

In various embodiments, the device 14 can also perform a function of blending different colors included in the light radiation emitted by the source L, for example with a function of homogenizing the chromatic features of the light radiation projected toward the lighting zone.

Reflectors 10 and domes 14 of the type illustrated here are known in the art, and it is therefore unnecessary at this point to provide a detailed description, unless it concerns some features illustrated in more detail hereinbelow.

Again, FIGS. 6 and 7 aim to highlight the fact that reflectors of the type under consideration here may be available in differing dimensions and shapes depending on the specific lighting requirements which are to be satisfied.

In various embodiments, different types of reflector 10 and/or of anti-glare/blending device 14 may be present, together with an adapter 16 described in further detail hereinbelow, in an assortment of accessories made available within the context of a modular lighting system.

All that with the possibility for an installer and/or a final user to choose, depending on the requirements for use, which accessories should be associated with a lighting source L (this too possibly being chosen within the context of an assortment of sources L of differing type). All of this preferably comes with the possibility to use a single type of universal adapter device 16 for this purpose.

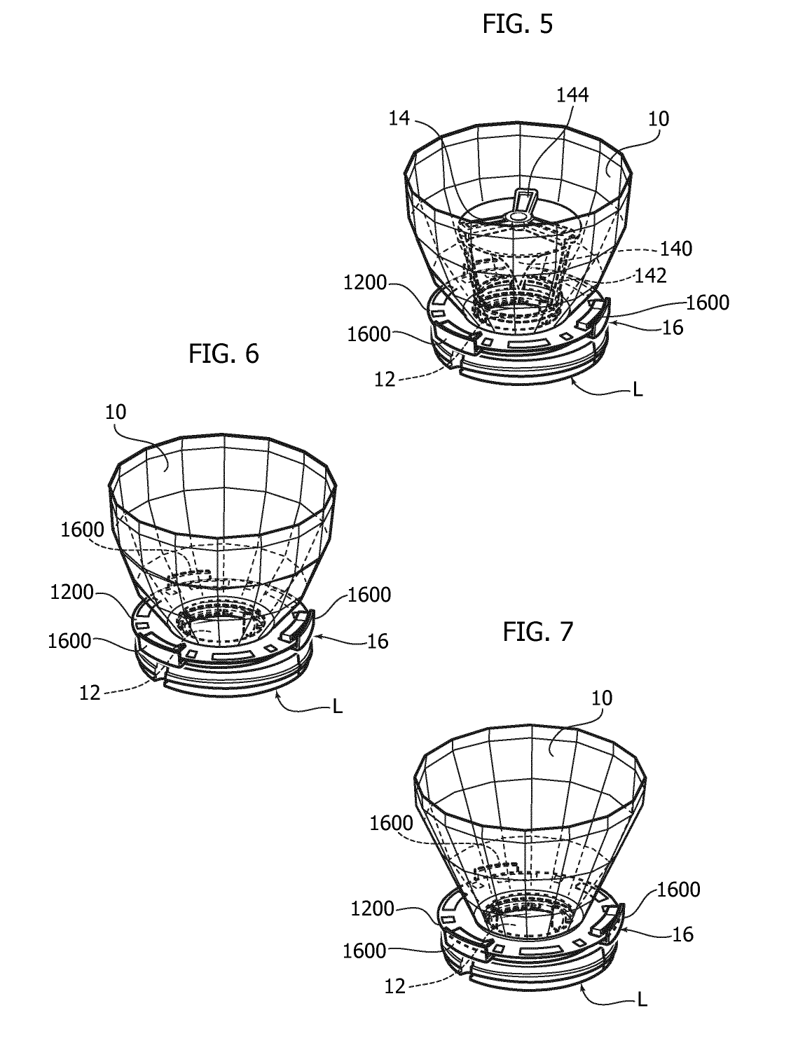

In this respect, reference should once again be made to the fact that, depending on the specific applicable requirements, it is possible for the following to be coupled to a lighting source L:
just the reflector 10 (see for example FIGS. 4, 6 and 7),
just the anti-glare device 14 (see for example FIG. 3),
both the reflector 10 and the anti-glare device 14 (see for example FIG. 5).

In various embodiments, the adapter 16 may be present in the form of a ring body which can be fitted to the light radiation source L, i.e. arranged at least approximately around said source. The central hole of the adapter 16 can thus be traversed by the light radiation, which is thus able to propagate both through the proximal opening 12 of the reflector 10 and toward the anti-glare device 14.

In various embodiments, the adapter 16 can be provided with a smooth and reflective inner surface. In various embodiments, this surface can be defined by an insert 160 of tubular form, which is provided with a smooth and reflective inner surface and can be arranged inside the body of the adapter 16. All that in such a way that the light radiation is not dispersed laterally, but rather, as it were, is channelled by the inner surface of the insert 160 toward the reflector 10 and/or the anti-glare device 14.

In various embodiments, the body of the adapter 16 and the insert 160 (which for all intents and purposes can be considered to be part of the adapter 16) can be made of different materials: for example a plastic material for the body 16 and a metallic material for the tubular insert 160.

In various embodiments, the insert 160 can be connected to the remaining part of the adapter 16, for example by means of screws (not visible in the drawings) passing through radial tabs 162 protruding from the insert 160.

In various embodiments, the insert 160 can be formed in one piece with the remaining part of the adapter 16.

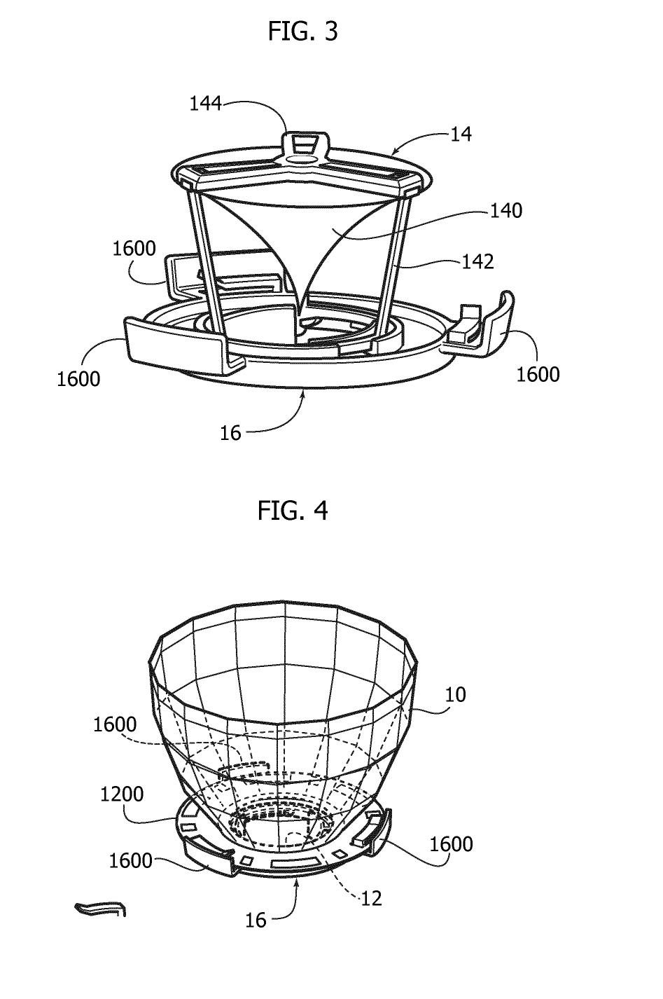

As can be seen more clearly in the view of FIG. 2, in which the adapter 16 is shown on its own, in various embodiments the adapter 16 can have an outer rim 16a and an inner rim 16b which are intended to allow for coupling, respectively with:
a reflector 10, and
an anti-glare device 14.

In various embodiments, the adapter 16 can therefore be configured in such a way as to allow for both said accessory elements to be coupled to the source L. This is also the case if, as already mentioned a number of times, the accessory elements 10 and 14 do not have to be present together.

In order to allow for the coupling with a reflector 10, in various embodiments the outer rim 16a of the adapter 16 can be provided with a plurality of pod-like parts 1600 (for example three of these, at an equal angular spacing of 120° along the contour of the adapter 16) which can be coupled, for example according to a general bayonet configuration, with an annular flange 1200 which protrudes starting from the contour 12a of the proximal opening 12 of the reflector 10.

In various embodiments, this coupling arrangement can make it possible to realize the elements 1600 carried by the adapter 16 as being formed by a type of L-shaped pod having a “horizontal” branch 1600a (which extends in the radial direction with respect to the body of the adapter 16) and a “vertical” branch 1600b (which extends in the axial direction with respect to the body of the adapter 16). All of this with the vertical branches 1600b of the various formations 1600, which can extend along a common circumference centered with respect to the general annular progression of the adapter 16, thus forming a series of radial containment elements, which are able to center the proximal opening 12 of the reflector 10 with respect to the adapter 16 (and therefore with respect to the light radiation source L).

For this purpose, in various embodiments the flange 1200 can be a flat annular body in the form of a circular crown of constant size. The “horizontal” branches 1600a and the flange 1200 can therefore bear the complementary elements of a bayonet coupling: for example teeth provided on the branches 1600a and openings provided in the flange 1200 (the arrangement may, however, be inverted, with the teeth on the flange 1200 and the holes on the branches 1600a), so as to allow for the coupling and the firm retention of the reflector 10 with respect to the adapter 16.

The latter can then be connected to the source L in various ways, for example by screwing or a positive fit, for example bayonet coupling: the specific methods for connection can vary depending on the type of source L, which, as already mentioned, may not be part of the embodiments per se.

In various embodiments, in addition to a diffusing screen 140 (having, in the exemplary embodiments under consideration here, a trumpet-like profile (rotary hyperboloid) which diverges away from the source L), the anti-reflective device 14 includes a cage-like support structure.

In the exemplary embodiment under consideration here, this structure includes a kind of tripod 142 formed by three legs emerging from a lower ring. The tripod-like structure 142, which is able to receive the screen 140 on its inside, is closed at the top by a three-lobe element 144, which is connected to the distal ends of the legs of the tripod 142 so as to keep the screen 140 in the desired centered mounting position on the structure which is shown (as is clearly visible in FIG. 3).

In various embodiments, the elements described, for example the element 144, may have varying shapes depending on an improved esthetic function.

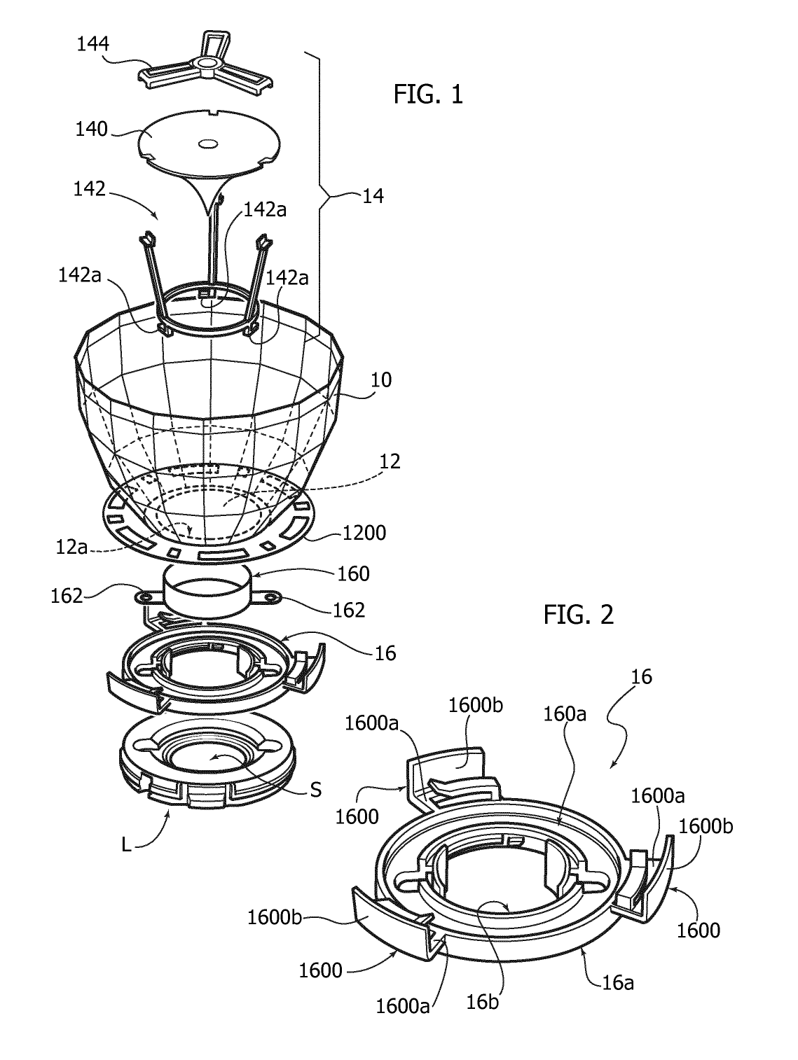

In various embodiments, the coupling of the anti-glare device 14 to the adapter 16 is based on the presence, as a coupling formation provided on the inner rim 16b of the adapter 16, of an annular groove 160a, into which teeth 142a (see FIG. 1 also with reference to FIG. 3) carried by the lower ring of the structure 142 engage.

As can be seen more clearly in the view of FIG. 2, the adapter 16 preferably has a channel-like profile (on the side facing toward the reflector 16), with the resultant possibility that the rim 12a of the proximal opening 12 of the reflector 10 can protrude into said channel-like profile, with a further function of centering the reflector 10 with respect to the adapter 16 (and therefore with respect to the source L).

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A process for equipping a solid state lighting source with at least one of:
a reflector having a proximal opening for receiving the light radiation of the source, and
an anti-glare device which has a support structure and is located at a position facing the source to be impinged upon by the light radiation of the source,
the process comprising:
fitting onto said source a ring adapter with a smooth reflective inner surface to reflect the light radiation, said ring adapter having an outer rim coupleable to the proximal opening of a reflector and an inner rim coupleable with the support structure of the anti-glare device, and
at least one of:
coupling to the source a reflector by coupling the proximal opening of the reflector with the outer rim of the adapter, and
coupling to the source the anti-glare device by coupling the support structure of the anti-glare device with the inner rim of the adapter.

2. The process as claimed in claim 1, wherein the adapter comprises: an annular body sized and dimensioned to be fitted onto said solid state lighting source,
a smooth reflective inner surface to reflect the light radiation,
an outer rim carrying first coupling formations coupleable with a proximal opening of a reflector, and
an inner rim carrying second coupling formations coupleable with the support structure of an anti-glare device.

3. The process as claimed in claim 2, wherein the adapter further comprises a tubular insert fittable to said inner rim, the inner surface of said insert defining said smooth reflective inner surface.

4. The process as claimed in claim 2, wherein said outer rim includes a plurality of pod-like elements coupleable with the rim of said proximal opening of said reflector.

5. The process as claimed in claim 2, wherein said inner rim is provided with a groove forming a mating surface for the support structure of said anti-glare device.

6. The process as claimed in claim 2, wherein the adapter has a channel-like profile to receive the rim of said proximal opening of said reflector.

7. The process as claimed in claim 1, wherein the reflector comprises a flange surrounding said proximal opening, said flange being coupleable with the outer rim of said adapter.

8. The process as claimed in claim 1, wherein the anti-glare device comprises a support structure provided with coupling formations for coupling with the inner rim of said adapter, said coupling formations including toothed formations engageable in a groove of the inner rim of the adapter.

9. The process as claimed in claim 8, wherein the anti-glare device comprises at least one of:
said support structure has a cage-like, preferably tripod-like, structure,
said support structure includes a retaining element for holding an anti-glare member on said support structure.

10. (canceled)
